(19) United States
(12) Patent Application Publication
(10) Pub. No.: US 2025/0092222 A1
(43) Pub. Date: Mar. 20, 2025

(54) POLYMER SURFACE MODIFICATION VIA FILLER ADDITION

(71) Applicants: CiDRA Corporate Services LLC, Wallingford, CT (US); BYK-Chemie GmbH, Wesel (DE)

(72) Inventor: Michael Stephen RYAN, Newtown, CT (US)

(21) Appl. No.: 18/727,407

(22) PCT Filed: Jan. 31, 2023
(86) PCT No.: PCT/US2023/011938

§ 371 Date: Jul. 9, 2024

Related U.S. Application Data
(60) Provisional application No. 63/304,804, filed on Jan. 31, 2022.

(51) Int. Cl. C08K 3/36

(52) U.S. Cl. CPC C08K 3/36

(57) ABSTRACT

Apparatus is provided for separating valuable material from unwanted material in a mixture, featuring engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy. The filler addition includes hydrophilic or hydrophobic silica added to a pre-cured polymer, including a pre-cured urethane foam; or a hydroxyl, an amine, a carboxyl, a carbonyl or an ester, all having reactive functionality or surface energy properties to enhance the coating adhesion and modify the polymer surface energy. The engineered media is formed by a composite of a polyurethane foam and silica, including either a hydrophilic silica or a hydrophobic silica.

### CROSS-REFERENCE TO RELATED APPLICATIONS

This application claims benefit to provisional application Ser. No. 63/304,804, filed 31 Jan. 2022 (Docket no. 712-002.468/CCS-0217), entitled “Polymer surface modification via filler additives,” which is hereby incorporated by reference in its entirety.

### 1. FIELD OF THE INVENTION

This invention relates generally to a method and apparatus for processing mineral product for the recovery of minerals in a slurry which is a mixture of water and coarse ore particles. In particular, this invention relates to a collection media for attracting mineral particles.

### 2. DESCRIPTION OF RELATED ART

In many industrial processes, flotation is used to separate valuable or desired material from unwanted material. By way of example, in this process a mixture of water, valuable material, unwanted material, chemicals and air is placed into a flotation cell. The chemicals are used to make the desired material hydrophobic and the air is used to carry the material to the surface of the flotation cell. When the hydrophobic material and the air bubbles collide, they become attached to each other. The bubble rises to the surface carrying the desired material with it.

The performance of the flotation cell is dependent on the air bubble surface area flux and air bubble size distribution in the collection zone of the cell. The air bubble surface area flux is dependent on the size of the bubbles and the air injection rate. Controlling the air bubble surface area flux has traditionally been very difficult. This is a multivariable control problem and there are no dependable real time feedback mechanisms to use for control.

Froth flotation is a process widely used for separating the valuable minerals from gangue. Flotation works by taking advantage of differences in the hydrophobicity of the mineral-bearing ore particles and the waste gangue. In this process, the pulp slurry of hydrophobic particles and hydrophilic particles is introduced to a water filled tank containing surfactant/frother which is aerated, creating bubbles. The hydrophobic particles attach to the air bubbles, which rise to the surface, forming a froth. The froth is removed and the concentrate is further refined.

In standard flotation separation, air is constantly forced through the pulp slurry to create a certain ‘flux’ of air passing through the pulp. This process, while now used widely, and refined over many decades of use, has limitations:
Due to the natural dynamics of the bubbles, a mineral-bearing particle may not typically be carried to the surface on one bubble, but may have to attach to several bubbles to reach the froth layer.
Larger particles containing minerals may not be lifted due to the limited buoyancy of a bubble, and the attractive forces between the bubble and the ore particle (created by the collector/hydrophobic chemical additives).

Thus, collection media having a surface layer made from a polymer coated with a hydrophobic material, instead of air bubbles, are used to attract mineral particles.

Fillers are routinely added to polymers to effect improved mechanical properties. The fillers themselves are often surface-modified in order to maximize their effectiveness in this regard. Additionally, polymers may be chemically altered in order to effect changes in mechanical and surface properties.

While the aforementioned devices utilize filler for mechanical property improvement, they don't provide surface functionality for coating adhesion. Alternatively, chemical modification of the polymer itself is often difficult, expensive (as different applications may require different chemical modifications), and may harm other properties of the system.

In view of the aforementioned, there is a need in the industry for a better polymer for making the collection media to be used for the recovery of the minerals.

### SUMMARY OF THE INVENTION

In the present invention, certain fillers are added to the polymer to impart surface functionality with the purpose of improving coating adhesion. Additionally, surface energy may be modified.

In particular, various polymers will have defined surface properties such as surface energy and available chemical functional groups such as hydroxyl, amine, carboxyl, sulfate, etc. In some cases, the polymer surface won't have available functional groups with which a coating may bond with; making coating adhesion difficult. Additionally, the polymer surface energy may be incompatible with the coating which inhibits wetting of the coating on the polymer substrate. The incompatibility of the surface energies may also lead to lower coating adhesion.

This invention describes a simple and cost effective method to add surface functionality to a polymer while also providing the opportunity to alter it's surface energy. Various functional fillers can be added to a pre-polymer prior to curing. To the extent that the functional fillers become available on the polymer surface, they will provide the necessary functionality with which the coating may bond. These fillers may also alter the surface energy of the polymer.

Examples include the addition of functional fillers to urethane foam prior to cure. Hydrophilic silica may be added to the pre-cured urethane (i.e., the diisocyanate and polyol admixture). After the curing and blowing operation, some of the silica will be present on the surface and bonded into the polyurethane. This silica will provide hydroxyl functionality with which the coating may form both hydrogen and covalent bonds with. As silica is a strong hydrogen bonder, it may enhance the base polyurethane strength as well. Another example is the use of hydrophobic silica as functional filler. When added to the urethane pre-polymer, hydrophobic silica has the capability to preferentially migrate to the air-interface due to its high energy state in the hydrophilic urethane. Upon curing and blowing the foam, the foam surface will have a lower surface energy than standard polyurethane foam. This will provide a more compatible surface to coat hydrophobic coatings due to improved wetting. Additionally, hydrophobic silica contains unreacted hydroxyl functionality albeit lower than hydrophilic silica. These hydroxyl groups will provide opportunities for the coating to bond to. Due to the propensity of hydrophobic silica to migrate to the surface, lower concentrations may be used.

This technique is useful for a wide range of polymers in order to enhance coating adhesion and modify polymer surface energy. Any polymer could be modified in this way as long as the filler is functional and added to the pre-polymer prior to cure. Functional fillers include those with reactive functionality, such as hydroxyl, amine, carboxyl, carbonyl, ester, etc. This invention specifies certain optimal functional fillers to enhance specific available functionality.

The composite of hydrophilic silica with polyurethane foam may then be coated with polydimethylsiloxane (PDMS). The PDMS silanols covalently react with and hydrogen bond to the hydroxyl functionality on the silica which is available on the polyurethane foam surface. This covalent bonding greatly enhances adhesion of the PDMS coating to the polyurethane foam surface. Alternatively, hydrophobic silica may be used as a composite in polyurethane foam. This will provide a lower energy foam surface which will allow improved wetting of the hydrophobic silicone coating. Additionally, the availability of some hydroxyl functionality on the hydrophobic silica will allow both hydrogen and covalent bonding of the silicone coating.

Other functional fillers include glass fiber, talc, mica, aluminosilicates or any solid particle with reactive functionality or with surface energy properties that are desired in the polymer substrate. What distinguishes this invention is that the filler is not necessarily selected to improve the mechanical or electrical properties of the substrate, though that could be a benefit as well, but is designed to provide reactive functionality or surface energy modification at the polymer substrate surface in order to improve coating adhesion.

Nearly all polymer substrates can benefit from this invention. For example, polyethylene (PE) and polypropylene (PP) are nearly inert surfaces and are difficult to bond to. However, when a composite is made with a reactive filler, that polymer surface now has reactive functionality available to bond with a coating. Similarly, if a high surface energy filler such as hydrophilic silica or glass fibers are added, then the PE and PP surface energy will increase and be more receptive to a high surface energy coating.

### Specific Embodiments

According to some embodiments, the present invention may include, or take the form of, the following specific embodiments for separating valuable material from unwanted material in a mixture.

### Apparatus

The present invention may include, or take the form of, apparatus featuring engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy.

The apparatus may include one or more of the following features:

The filler addition may include
hydrophilic silica added to a pre-cured polymer, including a pre-cured urethane foam;
hydrophobic silica added to a pre-cured polymer, including a pre-cured urethane foam; or
a hydroxyl, an amine, a carboxyl, a carbonyl or an ester, all having reactive functionality or surface energy properties to enhance the coating adhesion and modify the polymer surface energy.

The engineered media may be formed by a composite of a polyurethane foam and silica, including either a hydrophilic silica or a hydrophobic silica.

The composite of the polyurethane foam and the hydrophilic silica may be coated with polydimethylsiloxane (PDMS) having PDMS silanols to attract the valuable material in the mixture, so that the PDMS silanols covalently react with and hydrogen bond to hydroxyl functionality on the hydrophilic silica on a polyurethane foam surface of the polyurethane foam.

The composite of the polyurethane foam and the hydrophobic silica may be coated with hydrophobic silicone to attract the valuable material in the mixture, so that hydroxyl functionality on the hydrophobic silica allows both hydrogen and covalent bonding of the hydrophobic silicone coated on the polyurethane foam.

The body may include a conveyor belt made from the composite of the polyurethane foam and silica, including either the hydrophilic silica or the hydrophobic silica.

The body may include a filter made from the composite of the polyurethane foam and silica, including either the hydrophilic silica or the hydrophobic silica.

The filler addition may include glass fiber, talc, mica or aluminosilicates, all having reactive functionality or surface energy properties to enhance the coating adhesion and modify the polymer surface energy.

The polymer may include polyethylene (PE), polypropylene (PP), or polyurethane.

The coating may be made of a hydrophobic material selected from poly(dimethylsiloxane), polysiloxanates and fluoroalkylsilane.

The synthetic material may include a polymer-based material, silica-based material or ceramic-based material.

The body may include a synthetic bead having the polymer surface, and the synthetic bead is made of a material having a density less than the density of water.

The engineered media may include a three-dimensional open-cell structure made of a material selected from the group consisting of polyester urethanes (PU), reinforced urethanes, composites like polyvinylchloride (PVC) coated PU, carbon fiber foams and hard plastics.

The engineered media may include synthetic beads, each having the polymer surface.

Each synthetic bead may be made from the polymer having the filler addition added prior to curing.

The engineered media may include one or more moving conveyor belts having the polymer surface.

The engineered media may include one or more filters having the polymer surface.

The engineered media may form a resulting product characterized as either a filler-enhanced foam, a silica-enhanced composite polymer

### The Method

The present invention may include, or take the form of, a method for separating valuable material from unwanted material in a mixture featuring the steps of:
forming engineered media made of synthetic material from a body having a polymer surface with a coating functionalized to attract valuable material in a mixture;
configuring the polymer surface from a polymer having a filler addition added prior to curing in order to enhance coating adhesion and modify polymer surface energy; and
separating valuable material from unwanted material in a mixture using the engineered media.

The method may also include one or more of the features set forth herein.

### A System

The present invention may include, or take the form of, a system for separating valuable material from unwanted material in a mixture, featuring engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy in combination with one of the following:
(1) A combination of:
   (1A) an attachment flotation column configured to receive the engineered media and a mixture having valuable material and unwanted material, and provide enriched engineered media having the valuable material attached thereto; and
   (1B) a release flotation column configured to receive the enriched engineered media, and provide reclaimed engineered media and the valuable material released from the enriched engineered media; or
(2) A combination of:
   (2A) attachment apparatus configured to receive the engineered media in the form of a conveyor belt and a mixture having valuable material and unwanted material, and provide an enriched conveyor belt having the valuable material attached thereto; and
   (2B) release apparatus configured to receive the enriched conveyor belt, and provide a released conveyor belt and the valuable material released from the enriched conveyor belt; or
(3) A combination of:
   (3A) attachment apparatus configured to receive the engineered media in the form of a filter and a mixture having valuable material and unwanted material, and provide an enriched filter having the valuable material attached thereto; and
   (3B) release apparatus configured to receive the enriched filter, and provide a released filter belt and the valuable material released from the enriched filter.

The aforementioned systems may also include one or more of the features set forth herein.

### BRIEF DESCRIPTION OF THE DRAWING

Referring now to the drawing, which are not necessarily drawn to scale, the foregoing and other features and advantages of the present invention will be more fully understood from the following detailed description of illustrative embodiments, taken in conjunction with the accompanying drawing in which like elements are numbered alike:

FIG. 1 is a diagram of a flotation system, process or apparatus according to some embodiments of the present invention.

FIG. 2A shows a picture of reticulated form with Cu mineral entrained throughout the structure.

FIG. 2B is a picture of loaded media after exposure to tailings slurry containing 0.04% Cu and 0.011% MoS₂.

FIG. 3A illustrates a mineral laden synthetic bead, or loaded bead.

FIG. 3B illustrates part of a loaded bead having molecules to attract mineral particles.

FIGS. 4A to 4E illustrate an engineered bead with different shapes and structures.

FIG. 5 is diagram of a separation processor configured with two chambers, tanks or columns having a functionalized polymer coated conveyor belt arranged therein according to some embodiments of the present invention.

FIG. 6A is an illustration of a surface of an impeller according to some embodiments of the present invention.

FIG. 6B is an illustration of a section of a conveyor belt according to some embodiments of the present invention.

FIG. 6C is an illustration of a filter according to some embodiments of the present invention.

### DETAILED DESCRIPTION OF THE BEST MODE OF THE INVENTION

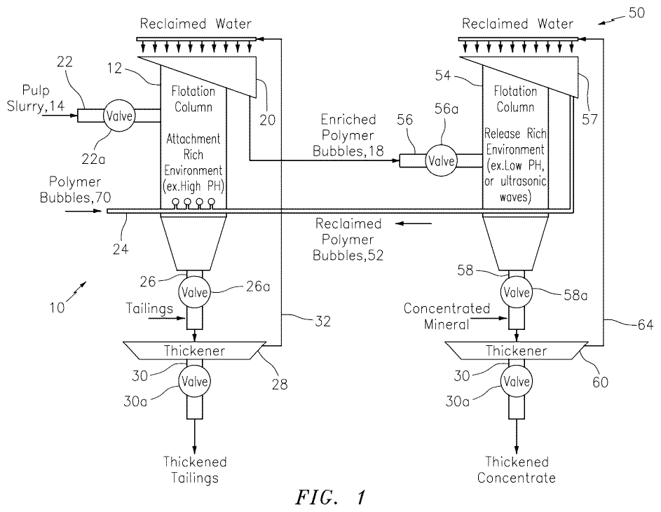

### FIG. 1

By way of example, FIG. 1 show an examples of a system or apparatus for separating valuable material from unwanted material in a mixture, e.g., that may use engineered media according to the present invention set forth herein, and consistent with that disclosed in the aforementioned applications and patents assigned to the assignee of the instant application and incorporated by reference herein, including PCT application no. PCT/US2013/034762 (Atty docket no. 712-002.379-1/CCS-0083) that corresponds to U.S. Pat. No. 10,245,597.

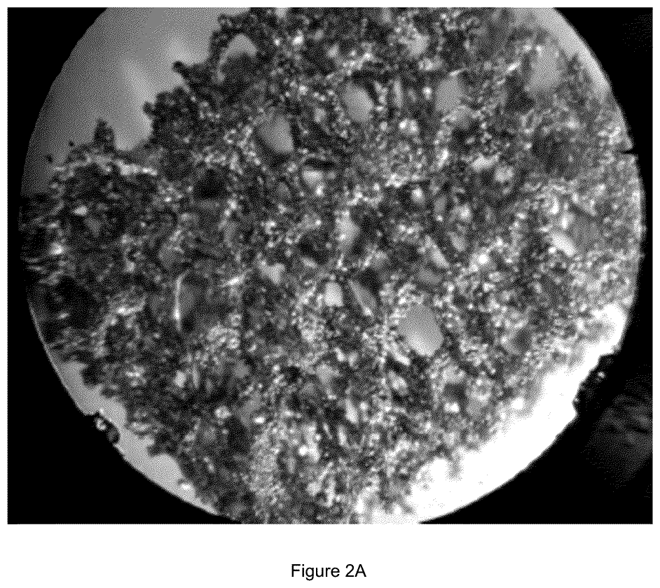

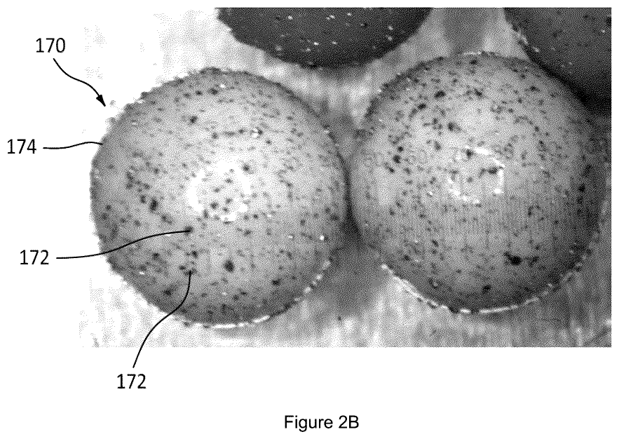

In particular, FIG. 1 shows apparatus 10, having a flotation cell or column 12 configured to receive a mixture of fluid (e.g. water), valuable material and unwanted material, e.g., a pulp slurry 14; receive synthetic bubbles/beads 70 (e.g., see also FIGS. 2B, 3A to FIG. 4E re element 170) that are constructed to be buoyant when submerged in the pulp slurry or mixture 14 and functionalized to control the chemistry of a process being performed in the flotation cell or column, including to attach to the valuable material in the pulp slurry or mixture 14; and provide enriched synthetic bubble/beads 18 having the valuable material attached thereon. The synthetic bubbles/beads like 18, 52, 70 may be formed as engineered media, e.g., according to some embodiments of the present invention.

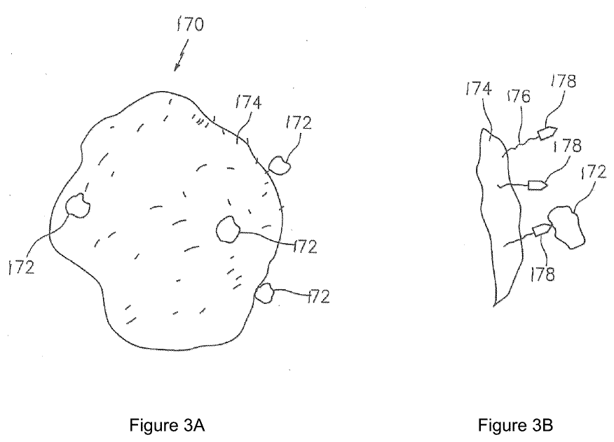

The terms “synthetic bubbles/beads” and “polymer bubbles/beads” are used interchangeably in this disclosure. The terms “valuable material”, “valuable mineral” and “mineral particle” are also used interchangeably. By way of example, the synthetic bubbles/beads like 18, 52, 70 may be made from polymer or polymer-based materials, or silica or silica-based materials, or glass or glass-based materials, although the scope of the invention is intended to include other types or kinds of material either now known or later developed in the future. For the purpose of describing one example of the present invention, in FIG. 1 the synthetic bubbles/beads 70 (e.g., see also FIGS. 2B, 3A thru 4E re element 170) are also shown and labeled as the enriched synthetic bubble or beads 18 and the reclaimed bubble/beads 52. The flotation cell or column 12 is configured with a top portion or piping 20 to provide the enriched polymer or polymer-based bubbles/beads 18 from the flotation cell or column 12 for further processing consistent with that set forth herein.

The flotation cell or column 12 may be configured with a top part or piping 22, e.g., having a valve 22a, to receive the pulp slurry or mixture 14 and also with a bottom part or piping 24 to receive the synthetic bubbles/beads 70. In operation, the buoyancy of the synthetic bubbles/beads 70 causes them to float upwardly from the bottom to the top of the flotation cell or column 12 through the pulp slurry or mixture 14 in the flotation cell or column 12 so as to collide with the water, valuable material and unwanted material in the pulp slurry or mixture 14. The functionalization of the synthetic bubbles/beads 70 causes them to attach to the valuable material in the pulp slurry or mixture 14. As used herein, the term “functionalization” means that the properties of the material making up the synthetic bubbles/beads 70 are either selected (based upon material selection) or modified during manufacture and fabrication, to be “attracted” to the valuable material, so that a bond is formed between the synthetic bubbles/beads 70 and the valuable material, so that the valuable material is lifted through the cell or column 12 due to the buoyancy of the synthetic bubbles/beads 70. For example, the surface of synthetic bubbles/beads has functional groups for collecting the valuable material. Alternatively, the synthetic bubbles/beads are functionalized to be hydrophobic for attracting wetted mineral particles-those mineral particles having collector molecules attached thereto. As a result of the collision between the synthetic bubbles/beads 70 and the water, valuable material and unwanted material in the pulp slurry or mixture 14, and the attachment of the synthetic bubbles/beads 70 and the valuable material in the pulp slurry or mixture 14, the enriched polymer or polymer-based bubbles 18 having the valuable material attached thereto will float to the top of the flotation cell 12 and form part of the froth formed at the top of the flotation cell 12. The flotation cell 12 may include the top part or piping 20 configured to provide the enriched polymer or polymer-based bubbles 18 having the valuable material attached thereto, which may be further processed consistent with that set forth herein. In effect, the enriched polymer or polymer-based bubbles 18 may be taken off the top of the flotation cell 12 or may be drained off by the top part or piping 20.

The flotation cell or column 12 may be configured to contain an attachment rich environment, including where the attachment rich environment has a high pH, so as to encourage the flotation recovery process therein. The flotation recovery process may include the recovery of ore particles in mining, including copper. The scope of the invention is not intended to be limited to any particular type or kind of flotation recovery process either now known or later developed in the future. The scope of the invention is also not intended to be limited to any particular type or kind of mineral of interest that may form part of the flotation recovery process either now known or later developed in the future.

The synthetic bubbles/beads 70 may be configured with a surface area flux by controlling some combination of the size of the polymer or polymer-based bubbles and/or the injection rate that the pulp slurry or mixture 14 is received in the flotation cell or column 12. The synthetic bubbles/beads 70 may also be configured with a low density so as to behave like air bubbles. The synthetic bubbles/beads 70 may also be configured with a controlled size distribution of medium that may be customized to maximize recovery of different feed matrixes to flotation as valuable material quality changes, including as ore quality changes.

The flotation cell or column 12 may be configured to receive the synthetic bubbles/beads 70 together with air, where the air is used to create a desired froth layer in the mixture in the flotation cell or column 12 in order to achieve a desired grade of valuable material. The synthetic bubbles/beads 70 may be configured to lift the valuable material to the surface of the mixture in the flotation cell or column.

### The Thickener 28

The apparatus 10 may also include piping 26 having a valve 26a for providing tailings to a thickener 28 configured to receive the tailings from the flotation cell or column 12. The thickener 28 includes piping 30 having a valve 30a to provide thickened tailings. The thickener 28 also includes suitable piping 32 for providing reclaimed water back to the flotation cell or column 12 for reuse in the process. Thickeners like element 28 are known in the art, and the scope of the invention is not intended to be limited to any particular type or kind either now known or later developed in the future.

### The Bead Recovery Process or Processor 50

The apparatus 10 may further comprises a bead recovery process or processor generally indicated as 50 configured to receive the enriched polymer or polymer-based bubbles/beads 18 and provide reclaimed polymer or polymer-based bubbles/beads 52 without the valuable material attached thereon so as to enable the reuse of the polymer or polymer-based bubbles/beads 52 in a closed loop process. By way of example, the bead recovery process or processor 50 may take the form of a washing station whereby the valuable mineral is mechanically, chemically, or electro-statically removed from the polymer or polymer-based bubbles/beads 18.

The bead recovery process or processor 50 may include a releasing apparatus in the form of a second flotation cell or column 54 having piping 56 with a valve 56a configured to receive the enriched polymer bubbles/beads 18; and substantially release the valuable material from the polymer bubbles/beads 18, and also having a top part or piping 57 configured to provide the reclaimed polymer bubbles/beads 52, substantially without the valuable material attached thereon The second flotation cell or column 54 may be configured to contain a release rich environment, including where the release rich environment has a low pH, or including where the release rich environment results from ultrasonic waves pulsed into the second flotation cell or column 54.

The bead recovery process or processor 50 may also include piping 58 having a valve 56a for providing concentrated minerals to a thickener 60 configured to receive the concentrated minerals from the flotation cell or column 54. The thickener 60 includes piping 62 having a valve 62a to provide thickened concentrate. The thickener 60 also includes suitable piping 64 for providing reclaimed water back to the second flotation cell or column 54 for reuse in the process. Thickeners like element 60 are known in the art, and the scope of the invention is not intended to be limited to any particular type or kind either now known or later developed in the future.

Embodiments are also envisioned in which the enriched synthetic beads or bubbles are placed in a chemical solution so the valuable material is dissolved off, or are sent to a smelter where the valuable material is burned off, including where the synthetic beads or bubbles are reused afterwards.

### Dosage Control

The synthetic beads or bubbles 70 may be functionalized to control the chemistry of the process being performed in the cell or column, e.g. to release a chemical to control the chemistry of the flotation separation process.

In particular, the flotation cell or column 12 in FIG. 1 may be configured to receive polymer-based blocks like synthetic beads containing one or more chemicals used in a flotation separation of the valuable material, including mining ores, that are encapsulated into polymers to provide a slow or targeted release of the chemical once released into the flotation cell or column 12. By way of example, the one or more chemicals may include chemical mixes both now known and later developed in the future, including typical frothers, collectors and other additives used in flotation separation. The scope of the invention is not intended to be limited to the type or kind of chemicals or chemical mixes that may be released into the flotation cell or column 12 using the synthetic bubbles according to the present invention.

The scope of the invention is intended to include other types or kinds of functionalization of the synthetic beads/bubbles 70 in order to provide other types or kinds of control of the chemistry of the process being performed in the cell or column, including either functionalizations and controls both now known and later developed in the future. For example, the synthetic beads or bubbles may be functionalized to control the pH of the mixture that forms part of the flotation separation process being performed in the flotation cell or column.

### FIGS. 2A and 2B

By way of example, FIGS. 2A and 2B show examples of engineered media according to some embodiments of the present invention, e.g., that may be used in, or form part of, a system or apparatus like that shown in FIG. 1 for separating valuable material from unwanted material in a mixture, e.g., consistent with that disclosed in the aforementioned applications and patents assigned to the assignee of the instant application and incorporated by reference herein, including PCT application no. PCT/US16/62242 (Atty docket no. 712-002.426-1/CCS-0154).

In particular, FIG. 2A shows an example of a section of polymer coated reticulated foam used for recovery of Chalcopyrite, wherein mineral particles captured copper ore slurry can be seen throughout the foam network.

Open-cell foam and sponge-like material can be as engineered collection media. Open cell or reticulated foam offers an advantage over other media shapes such as the sphere by having higher surface area to volume ration. Applying a functionalized polymer coating that promotes attachment of mineral to the foam “network” enables higher recovery rates and improved recovery of less liberated mineral when compared to the conventional process. For example, open cells allow passage of fluid and particles smaller than the cell size but capture mineral bearing particles the come in contact with the functionalized polymer coating. Selection of cell size is dependent upon slurry properties and application.

The coated foam may be cut in a variety of shapes and forms. For example, a polymer coated foam belt can be moved through the slurry to collect the desired minerals and then cleaned to remove the collected desired minerals. The cleaned foam belt can be reintroduced into the slurry. Strips, blocks, and/or sheets of coated foam of varying size can also be used where they are randomly mixed along with the slurry in a mixing cell. The thickness and cell size of a foam can be dimensioned to be used as a cartridge-like filter which can be removed, cleaned of recovered mineral, and reused. As mentioned earlier, the open cell or reticulated foam, when coated or soaked with hydrophobic chemical, offers an advantage over other media shapes such as sphere by having higher surface area to volume ratio. Surface area is an important property in the mineral recovery process because it defines the amount of mass that can be captured and recovered. High surface area to volume ratios allows higher recovery per unit volume of media added to a cell.

The open cell or reticulated foam provides functionalized three dimensional open network structures having high surface area with extensive interior surfaces and tortuous paths protected from abrasion and premature release of attached mineral particles. This provides for enhanced collection and increased functional durability. Spherical shaped recovery media, such as beads, and also of belts, and filters, is poor surface area to volume ratio—these media do not provide high surface area for maximum collection of mineral. Furthermore, certain media such as beads, belts and filters may be subject to rapid degradation of functionality.

Applying a functionalized polymer coating that promotes attachment of mineral to the foam “network” enables higher recovery rates and improved recovery of less liberated mineral when compared to the conventional process. This foam is open cell so it allows passage of fluid and particles smaller than the cell size but captures mineral bearing particles the come in contact with the functionalized polymer coating. Selection of cell size is dependent upon slurry properties and application.

A three-dimensional open cellular structure optimized to provide a compliant, tacky surface of low energy enhances collection of hydrophobic or hydrophobized mineral particles ranging widely in particle size. This structure may be comprised of open-cell foam coated with a compliant, tacky polymer of low surface energy. The foam may be comprised of reticulated polyurethane or another appropriate open-cell foam material such as silicone, polychloroprene, polyisocyanurate, polystyrene, polyolefin, polyvinylchloride, epoxy, latex, fluoropolymer, phenolic, EPDM, nitrile, composite foams and such. The coating may be a polysiloxane derivative such as polydimethylsiloxane and may be modified with tackifiers, plasticizers, crosslinking agents, chain transfer agents, chain extenders, adhesion promoters, aryl or alky copolymers, fluorinated copolymers, hydrophobizing agents such as hexamethyldisilazane, and/or inorganic particles such as silica or hydrophobic silica. Alternatively, the coating may be comprised of materials typically known as pressure sensitive adhesives, e.g. acrylics, butyl rubber, ethylene vinyl acetate, natural rubber, nitriles; styrene block copolymers with ethylene, propylene, and isoprene; polyurethanes, and polyvinyl ethers as long as they are formulated to be compliant and tacky with low surface energy.

The three-dimensional open cellular structure may be coated with a primer or other adhesion agent to promote adhesion of the outer collection coating to the underlying structure.

In addition to soft polymeric foams, other three-dimensional open cellular structures such as hard plastics, ceramics, carbon fiber, and metals may be used. Examples include Incofoam®, Duocel®, metal and ceramic foams produced by American Elements®, and porous hard plastics such as polypropylene honeycombs and such. These structures must be similarly optimized to provide a compliant, tacky surface of low energy by coating as above.

The three-dimensional, open cellular structures above may be coated or may be directly reacted to form a compliant, tacky surface of low energy.

The three-dimensional, open cellular structure may itself form a compliant, tacky surface of low energy by, for example, forming such a structure directly from the coating polymers as described above. This is accomplished through methods of forming open-cell polymeric foams known to the art.

The structure may be in the form of sheets, cubes, spheres, or other shapes as well as densities (described by pores per inch and pore size distribution), and levels of tortuosity that optimize surface access, surface area, mineral attachment/detachment kinetics, and durability. These structures may be additionally optimized to target certain mineral particle size ranges, with denser structures acquiring smaller particle sizes. In general, cellular densities may range from 10-200 pores per inch, more preferably 30-90 pores per inch, and most preferably 30-60 pores per inch.

The specific shape or form of the structure may be selected for optimum performance for a specific application. For example, the structure (coated foam for example) may be cut in a variety of shapes and forms. For example, a polymer coated foam belt could be moved through the slurry removing the desired mineral whereby it is cleaned and reintroduced into the slurry. Strips, blocks, and/or sheets of coated foam of varying size could also be used where they are randomly mixed along with the slurry in a mixing cell. Alternatively, a conveyor structure may be formed where the foam is encased in a cage structure that allows a mineral-containing slurry to pass through the cage structure to be introduced to the underlying foam structure where the mineral can react with the foam and thereafter be further processed in accordance with the present invention. The thickness and cell size could be changed to a form cartridge like filter whereby the filter is removed, cleaned of recovered mineral, and reused. The polymer coated reticulated foam may be used to recover Chalcopyrite mineral. Mineral particles captured from copper ore slurry can be seen throughout the foam network.

FIG. 2B shows an example of loaded engineered media in the form of a synthetic bead exposed to a tailings slurry containing 0.04% Cu and 0.011% MoS₂. As shown in FIG. 2B, each of the two loaded synthetic beads 170 has many specks of mineral particles 172 attached to a bead surface 174 of the engineered media or bead (synthetic bead) 170.

### FIGS. 3A and 3B

By way of example, FIGS. 3A and 3B show examples of engineered media according to some embodiments of the present invention, e.g., that may be used in, or form part of, a system or apparatus like that shown in FIG. 1 for separating valuable material from unwanted material in a mixture, e.g., consistent with that disclosed in the aforementioned applications and patents assigned to the assignee of the instant application and incorporated by reference herein, including PCT application no. PCT/US2017/059491 (Atty docket no. 712-002.440-1/CCS-0176), corresponding to U.S. Pat. No. 11,247,212.

In particular, FIG. 3A illustrates the engineered media in the form of a mineral laden synthetic bead, or loaded bead 170. As illustrated, the synthetic bead 170 can attract many mineral particles 172. FIG. 3B illustrates part of a loaded bead having a bead surface 174 with molecules (176, 178) to attract the mineral particles 172.

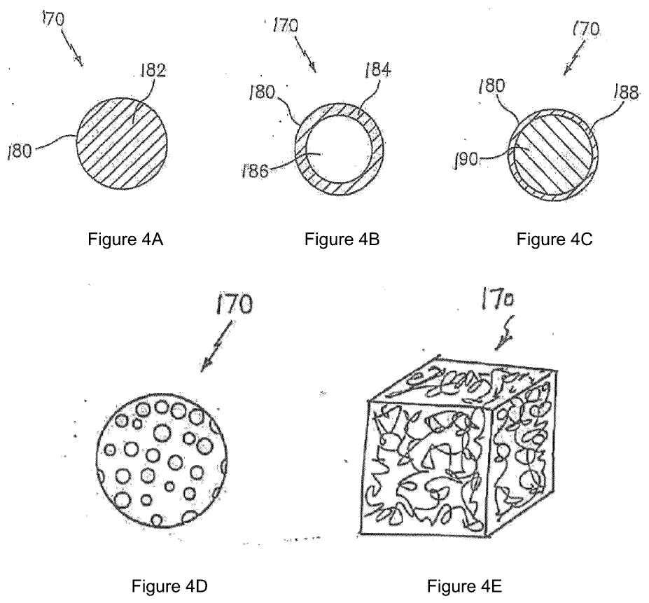

As shown in FIGS. 3A and 3B, the synthetic bead 170 has a bead body (e.g., see FIGS. 4A-4E re element 180) to provide a bead surface 174. At least the outside part of the bead body is made of a synthetic material, such as polymer, so as to provide a plurality of molecules or molecular segments 176 on the bead surface 174. The molecule 176 is used to attach a chemical functional group 178 to the bead surface 174. In general, the molecule 176 can be a hydrocarbon chain, for example, and the functional group 178 can have an anionic bond for attracting or attaching a mineral, such as copper to the bead surface 174. A xanthate, for example, has both the functional group 178 and the molecular segment 176 to be incorporated into the polymer that is used to make the synthetic bead 170. A functional group 178 is also known as a collector that is either ionic or non-ionic. The ion can be anionic or cationic. An anion includes oxyhydryl, such as carboxylic, sulfates and sulfonates, and sulfhydral, such as xanthates and dithiophosphates. Other molecules or compounds that can be used to provide the function group 178 include, but are not limited to, thionocarboamates, thioureas, xanthogens, monothiophosphates, hydroquinones and polyamines. Similarly, a chelating agent can be incorporated into or onto the polymer as a collector site for attracting a mineral, such. As shown in FIG. 7b, a mineral particle 172 is attached to the functional group 178 on a molecule 176. In general, the mineral particle 172 is much smaller than the synthetic bead 170. Many mineral particles 172 can be attracted to or attached to the bead surface 174 of the synthetic bead 170.

### FIGS. 4A to 4E

By way of example, FIGS. 4A to 4E show examples of engineered media according to some embodiments of the present invention, e.g., that may be used in, or form part of, a system or apparatus for separating valuable material from unwanted material in a mixture, e.g., consistent with that disclosed in the aforementioned applications and patents assigned to the assignee of the instant application and incorporated by reference herein, including the aforementioned PCT application no. PCT/US2017/059491 (Atty docket no. 712-002.440-1/CCS-0176).

In particular, the synthetic bead may be configured as a solid-phase body made of a synthetic material, such as polymer. The polymer can be rigid or elastomeric. An elastomeric polymer can be polyisoprene or polybutadiene, for example. The synthetic bead 170 has a bead body 180 having a bead surface (see FIGS. 3A and 3B re element 174) comprising a plurality of molecules with one or more functional groups for attracting mineral particles to the surface. A polymer having a functional group to collect mineral particles is referred to as a functionalized polymer. In one embodiment, the entire interior part 182 of the synthetic bead 170 is made of the same functionalized material, as shown in FIG. 4A. In another embodiment, the bead body 180 comprises a shell 184. The shell 184 can be formed by way of expansion, such as thermal expansion or pressure reduction. The shell 184 can be a micro-bubble or a balloon. In FIG. 4B, the shell 184, which is made of functionalized material, has an interior part 186. The interior part 186 can be filled with air or gas to aid buoyancy, for example. The interior part 186 can be used to contain a liquid to be released during the mineral separation process. The encapsulated liquid can be a polar liquid or a non-polar liquid, for example. The encapsulated liquid can contain a depressant composition for the enhanced separation of copper, nickel, zinc, lead in sulfide ores in the flotation stage, for example. The shell 184 can be used to encapsulate a powder which can have a magnetic property so as to cause the synthetic bead to be magnetic, for example. The encapsulated liquid or powder may contain monomers, oligomers or short polymer segments for wetting the surface of mineral particles when released from the beads. For example, each of the monomers or oligomers may contain one functional group for attaching to a mineral particle and an ion for attaching the wetted mineral particle to the synthetic bead. The shell 84 can be used to encapsulate a solid core, such as Styrofoam to aid buoyancy, for example. In yet another embodiment, only the coating of the bead body is made of functionalized polymer. As shown in FIG. 4C, the synthetic bead has a core 190 made of ceramic, glass or metal and only the surface of core 190 has a coating 188 made of functionalized polymer. The core 190 can be a hollow core or a filled core depending on the application. The core 190 can be a micro-bubble, a sphere or balloon. For example, a filled core made of metal makes the density of the synthetic bead to be higher than the density of the pulp slurry, for example. The core 190 can be made of a magnetic material so that the para-, ferri-, ferro-magnetism of the synthetic bead is greater than the para-, ferri-, ferro-magnetism of the unwanted ground ore particle in the mixture. In a different embodiment, the synthetic bead can be configured with a ferro-magnetic or ferri-magnetic core that attract to paramagnetic surfaces. A core 190 made of glass or ceramic can be used to make the density of the synthetic bead substantially equal to the density of the pulp slurry so that when the synthetic beads are mixed into the pulp slurry for mineral collection, the beads can be in a suspension state.

The synthetic bead 170 can be a porous block or take the form of a sponge or foam with multiple segregated gas filled chambers, e.g., as shown in FIGS. 4D and 4E.

It should be understood that the term “bead” does not limit the shape of the synthetic bead of the present invention to be spherical. In some embodiments of the present invention, the synthetic bead 170 can have an elliptical shape, a cylindrical shape, a shape of a block. Furthermore, the synthetic bead can have an irregular shape.

It should also be noted that the synthetic beads of the present invention can be realized by a different way to achieve the same goal. Namely, it is possible to use a different means to attract the mineral particles to the surface of the synthetic beads. For example, the surface of the polymer beads, shells can be functionalized with a hydrophobic chemical molecule or compound. The synthetic beads and/or engineered collection media can be made of a polymer. The term “polymer” in this specification means a large molecule made of many units of the same or similar structure linked together. Furthermore, the polymer can be naturally hydrophobic or functionalized to be hydrophobic. Some polymers having a long hydrocarbon chain or silicon-oxygen backbone, for example, tend to be hydrophobic. Hydrophobic polymers include polystyrene, poly(d,I-lactide), poly(dimethylsiloxane), polypropylene, polyacrylic, polyethylene, etc. The bubbles/beads, such as synthetic bead 170 can be made of glass to be coated with hydrophobic silicone polymer including polysiloxanates so that the bubbles/beads become hydrophobic. The bubbles/beads can be made of metal to be coated with silicone alkyd copolymer, for example, so as to render the bubbles/beads hydrophobic. The bubbles/beads can be made of ceramic to be coated with fluoroalkylsilane, for example, so as to render the bubbles/beads hydrophobic. The bubbles/beads can be made of hydrophobic polymers, such as polystyrene and polypropylene to provide a hydrophobic surface. The wetted mineral particles attached to the hydrophobic synthetic bubble/beads can be released thermally, ultrasonically, electromagnetically, mechanically or in a low pH environment.

The multiplicity of hollow objects, bodies, elements or structures may include hollow cylinders or spheres, as well as capillary tubes, or some combination thereof. The scope of the invention is not intended to be limited to the type, kind or geometric shape of the hollow object, body, element or structure or the uniformity of the mixture of the same.

One disadvantage of spherical shaped recovery media such as a bubble, is that it possesses a poor surface area to volume ratio. Surface area is an important property in the mineral recovery process because it defines the amount of mass that can be captured and recovered. High surface area to volume ratios allows higher recovery per unit volume of media added to a cell. As illustrated in FIG. 4E, open-cell foam and sponge-like material can be as engineered collection media. Open cell or reticulated foam offers an advantage over other media shapes such as the sphere by having higher surface area to volume ratio. Applying a functionalized polymer coating that promotes attachment of mineral to the foam “network” enables higher recovery rates and improved recovery of less liberated mineral when compared to the conventional process. For example, open cells allow passage of fluid and particles smaller than the cell size but capture mineral bearing particles the come in contact with the functionalized polymer coating. Selection of cell size is dependent upon slurry properties and application.

The coated foam may be cut in a variety of shapes and forms. For example, a polymer coated foam belt can be moved through the slurry to collect the desired minerals and then cleaned to remove the collected desired minerals. The cleaned foam belt can be reintroduced into the slurry. Strips, blocks, and/or sheets of coated foam of varying size can also be used where they are randomly mixed along with the slurry in a mixing cell. The thickness and cell size of a foam can be dimensioned to be used as a cartridge-like filter which can be removed, cleaned of recovered mineral, and reused.

As mentioned earlier, the open cell or reticulated foam, when coated or soaked with hydrophobic chemical, offers an advantage over other media shapes such as sphere by having higher surface area to volume ratio. Surface area is an important property in the mineral recovery process because it defines the amount of mass that can be captured and recovered. High surface area to volume ratios allows higher recovery per unit volume of media added to a cell.

The open cell or reticulated foam provides functionalized three dimensional open network structures having high surface area with extensive interior surfaces and tortuous paths protected from abrasion and premature release of attached minerals particles. This provides for enhanced collection and increased functional durability. Spherical shaped recovery media, such as beads, and also of belts, and filters, is poor surface area to volume ratio—these media do not provide high surface area for maximum collection of minerals. Furthermore, certain media such as beads, belts and filters may be subject to rapid degradation of functionality.

Applying a functionalized polymer coating that promotes attachment of minerals to the foam “network” enables higher recovery rates and improved recovery of less liberated minerals when compared to the conventional process. This foam is open cell so it allows passage of fluid and particles smaller than the cell size but captures mineral bearing particles the come in contact with the functionalized polymer coating. Selection of cell size is dependent upon slurry properties and application.

A three-dimensional open cellular structure optimized to provide a compliant, tacky surface of low energy enhances collection of hydrophobic or hydrophobized mineral particles ranging widely in particle size. This structure may be comprised of open-cell foam coated with a compliant, tacky polymer of low surface energy. The foam may be comprised of reticulated polyurethane or another appropriate open-cell foam material such as silicone, polychloroprene, polyisocyanurate, polystyrene, polyolefin, polyvinylchloride, epoxy, latex, fluoropolymer, phenolic, EPDM, nitrile, composite foams and such. The coating may be a polysiloxane derivative such as polydimethylsiloxane and may be modified with tackifiers, plasticizers, crosslinking agents, chain transfer agents, chain extenders, adhesion promoters, aryl or alky copolymers, fluorinated copolymers, hydrophobizing agents such as hexamethyldisilazane, and/or inorganic particles such as silica or hydrophobic silica. Alternatively, the coating may be comprised of materials typically known as pressure sensitive adhesives, e.g. acrylics, butyl rubber, ethylene vinyl acetate, natural rubber, nitriles; styrene block copolymers with ethylene, propylene, and isoprene; polyurethanes, and polyvinyl ethers as long as they are formulated to be compliant and tacky with low surface energy.

The three-dimensional open cellular structure may be coated with a primer or other adhesion agent to promote adhesion of the outer collection coating to the underlying structure.

In addition to soft polymeric foams, other three-dimensional open cellular structures such as hard plastics, ceramics, carbon fiber, and metals may be used. Examples include Incofoam®, Duocel®, metal and ceramic foams produced by American Elements®, and porous hard plastics such as polypropylene honeycombs and such. These structures must be similarly optimized to provide a compliant, tacky surface of low energy by coating as above.

The three-dimensional, open cellular structures above may be coated or may be directly reacted to form a compliant, tacky surface of low energy.

The three-dimensional, open cellular structure may itself form a compliant, tacky surface of low energy by, for example, forming such a structure directly from the coating polymers as described above. This is accomplished through methods of forming open-cell polymeric foams known to the art.

The structure may be in the form of sheets, cubes, spheres, or other shapes as well as densities (described by pores per inch and pore size distribution), and levels of tortuosity that optimize surface access, surface area, mineral attachment/detachment kinetics, and durability. These structures may be additionally optimized to target certain mineral particle size ranges, with denser structures acquiring smaller particle sizes. In general, cellular densities may range from 10-200 pores per inch, more preferably 30-90 pores per inch, and most preferably 30-60 pores per inch.

The specific shape or form of the structure may be selected for optimum performance for a specific application. For example, the structure (coated foam for example) may be cut in a variety of shapes and forms. For example, a polymer coated foam belt could be moved through the slurry removing the desired mineral whereby it is cleaned and reintroduced into the slurry. Strips, blocks, and/or sheets of coated foam of varying size could also be used where they are randomly mixed along with the slurry in a mixing cell. Alternatively, a conveyor structure may be formed where the foam is encased in a cage structure that allows a mineral-containing slurry to pass through the cage structure to be introduced to the underlying foam structure where the mineral can react with the foam and thereafter be further processed in accordance with the present invention. The thickness and cell size could be changed to a foam cartridge-like filter whereby the filter is removed, cleaned of recovered mineral, and reused.

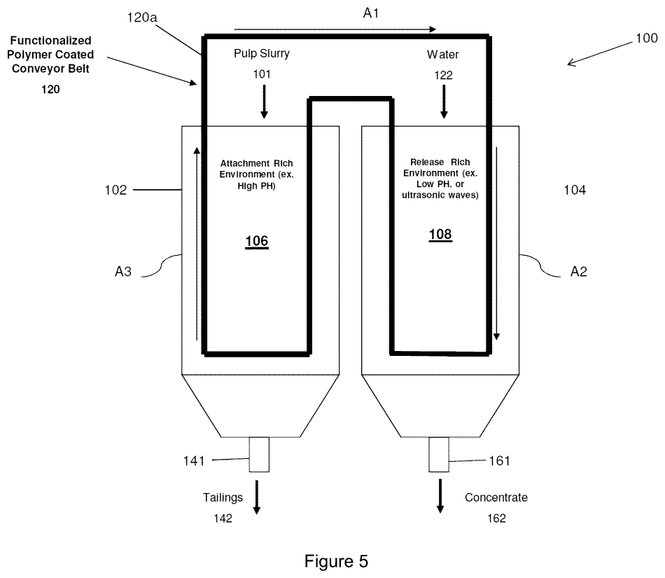

### FIG. 5: The Functionalized Polymer Coated Conveyor Belt

By way of example, FIG. 5 shows an example of engineered media according to some embodiments of the present invention in the form of a conveyor belt 120, e.g., that may be used in, or form part of, a system or apparatus for separating valuable material from unwanted material in a mixture, e.g., consistent with that disclosed in the aforementioned applications and patents assigned to the assignee of the instant application and incorporated by reference herein, including PCT application no. PCT/US 2015/066390 (Atty docket no. 712-002.417-1/CCS-0133), corresponding to U.S. Pat. No. 10,427,166.

In particular, FIG. 5 shows a machine, device, system or apparatus 100, e.g., for separating the valuable material from the unwanted material in the mixture 101, such as a pulp slurry, using a first processor 102 and a second processor 104. The first processor 102 and the second processor 104 are configured with a functionalized polymer coated member that is shown, e.g., as a functionalized polymer coated conveyor belt 120 that runs between the first processor 102 and the second processor 104. The functionalized polymer coated conveyor belt 120 may be formed as engineered media, e.g., according to some embodiments of the present invention.

In FIG. 5, the arrows A1, A2, A3 indicate the movement of the functionalized polymer coated conveyor belt 120. Techniques, including motors, gearing, etc., for running a conveyor belt like element 120 between two processors like elements 102 and 104 are known in the art, and the scope of the invention is not intended to be limited to any particular type or kind thereof either now know or later developed in the future. The functionalized polymer coated conveyor belt 120 may be made of a mesh material.

The first processor 102 may take the form of a first chamber, tank, cell or column that contains an attachment rich environment generally indicated as 106. The first chamber, tank or column 102 may be configured to receive the mixture or pulp slurry 101 in the form of fluid (e.g., water), the valuable material and the unwanted material in the attachment rich environment 106, e.g., which has a high pH, conducive to attachment of the valuable material. The second processor 104 may take the form of a second chamber, tank, cell or column that contains a release rich environment generally indicated as 108. The second chamber, tank, cell or column 104 may be configured to receive, e.g., water 122 in the release rich environment 108, e.g., which may have a low pH or receive ultrasonic waves conducive to release of the valuable material. Consistent with that stated above, attachment rich environments like that forming part of element environment 106 conducive to the attachment of a valuable material of interest and release rich environments like that forming part of environment 108 conducive to the release of the valuable material of interest are known in the art, and the scope of the invention is not intended to be limited to any particular type or kind thereof either now known or later developed in the future. Moreover, a person skilled in the art would be able to formulate an attachment rich environment like environment 106 and a corresponding release rich environment like environment 108 based on the separation technology disclosed herein for any particular valuable mineral of interest, e.g., copper, forming part of any particular mixture or slurry pulp.

In operation, the first processor 102 may be configured to receive the mixture or pulp slurry 101 of water, valuable material and unwanted material and the functionalized polymer coated conveyor belt 120 that is configured to attach to the valuable material in the attachment rich environment 106. In FIG. 5, the belt 120 is understood to be configured and functionalized with a polymer coating to attach to the valuable material in the attachment rich environment 106.

The first processor 102 may also be configured to provide drainage from piping 141 of, e.g., tailings 142 as shown in FIG. 5.

The first processor 102 may also be configured to provide an enriched functionalized polymer coated conveyor belt having the valuable material attached thereto, after passing through the attachment rich environment 106. In FIG. 5, the enriched functionalized polymer coated conveyor belt is shown, e.g., as that portion or part 120a of the belt 120 being provisioned from the attachment rich environment 106 in the first processor 102 to the release rich environment 108 in the second processor 104. It is understood that some other portions or parts of the belt 120 may be enriched, including the portion or part immediately leaving the attachment rich environment 106, as well as the portion or part immediately entering the release rich environment 108.

The second processor 14 may be configured to receive the fluid 122 (e.g. water) and the portion 120a of the enriched functionalized polymer coated conveyor belt 120 to release the valuable material in the release rich environment 108.

The second processor 104 may also be configured to provide the valuable material that is released from the enriched functionalized polymer coated member into the release rich environment 108. For example, in FIG. 5 the second processor 104 is shown configured to provide via piping 161 drainage of the valuable material in the form of a concentrate 162.

In FIG. 5, the first processor 102 is configured with the functionalized polymer coated conveyor belt 120 passing through with only two turns inside the attachment rich environment 106. However, embodiments are envisioned in which the first processor 102 may be configured to process the functionalized polymer coated conveyor belt 120 using a serpentine technique for winding or turning the belt 120 one way and another way, back and forth, inside the first processor to maximize surface area of the belt inside the processor 102 and exposure of the belt 120 to the attachment rich environment 106.

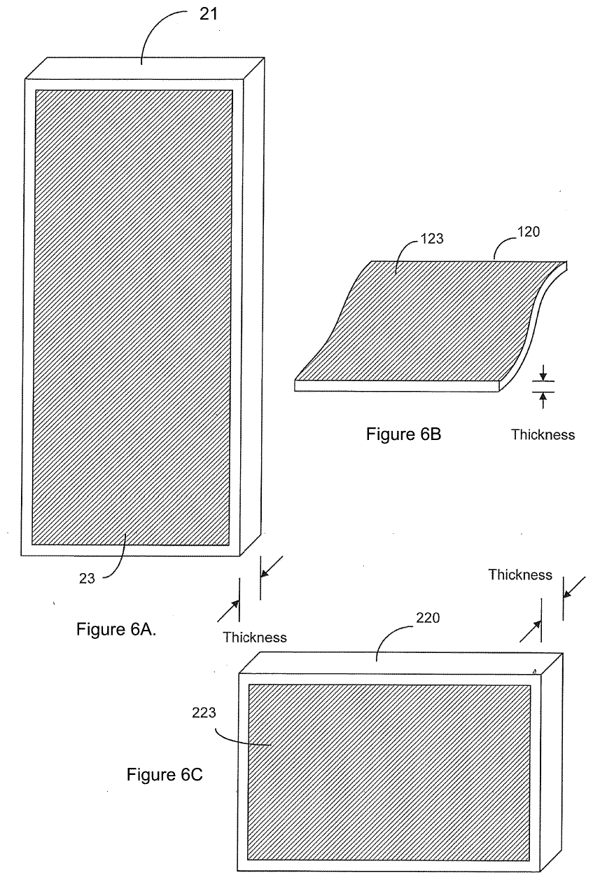

FIGS. 6A, 6B and 6C: Impeller, Conveyor Belt and Filter By way of example, FIGS. 6A, 6B and 6C shows examples of engineered media according to some embodiments of the present invention in the form of an impeller, conveyor belt and filter that may be used in, or form part of, a system or apparatus for separating valuable material from unwanted material in a mixture, e.g., consistent with that disclosed in the aforementioned applications and patents assigned to the assignee of the instant application and incorporated by reference herein.

FIG. 6A shows an impeller 21 having a collection area 23 that includes the engineered media e.g., that may include a functionalized polymer surface according to some embodiments of the present invention.

FIG. 6B shows a conveyor belt 120 having a collection area 123 that includes the engineered media, e.g., that may include a functionalized polymer surface according to some embodiments of the present invention.

FIG. 6C shows a filter 220 having a collection area 223 that includes the engineered media, e.g., that may include a functionalized polymer surface according to some embodiments of the present invention.

The collection areas 23, 123 and 223 can take many forms and have various surface features to attract the mineral particles of interest, when the impeller 21, conveyor belt 120 and the filter 220 are made contact with a mixture or pulp slurry that includes the valuable material.

### Summary

In summary, the present invention provides a new and unique enhanced polymeric material which can be used to collect mineral particles or valuable material in a pulp slurry. The enhanced polymeric material has a body made from a polymer with a filler addition. The filler addition is added to the polymer prior to curing.

According to some embodiments, the filler addition may include a hydrophilic silica added to a pre-cured polymer, including a pre-cured urethane foam. According to some embodiments, the filler addition may include a hydrophobic silica added to a pre-cured polymer, including a pre-cured urethane foam. According to some embodiments, the filler addition may include a hydroxyl, an amine, a carboxyl, a carbonyl or an ester. According to some embodiments, the polymer may be a polyurethane foam, the filler addition may be a hydrophilic silica, and the enhanced polymeric material may be coated with polydimethylsiloxane (PDMS) having PDMS silanols to attract the valuable material in the mixture, so that the PDMS silanols covalently react with and hydrogen bond to hydroxyl functionality on the hydrophilic silica on a polyurethane foam surface of the polyurethane foam. According to some embodiments, the filler addition may include glass fiber, talc, mica or aluminosilicates, all having reactive functionality or surface energy properties to enhance the coating adhesion and modify the polymer surface energy. According to some embodiments, the polymer may include polyethylene (PE), polypropylene (PP), or polyurethane.

The enhanced polymeric material, i.e., the filler addition added polymer, can be used to make the beads 70 in FIG. 1; the beads 170 in FIGS. 2B, 3A, 4A-4E; the belt 120 in FIGS. 5 and 6B; the impeller 20 in FIG. 4A; filter 220 in FIG. 4C; and the other collection surfaces for collecting mineral particles in a pulp slurry.

### THE RELATED FAMILY

This application is also related to a family of nine PCT applications, which were all concurrently filed on 25 May 2012, as follows:
PCT application no. PCT/US12/39528 (Atty docket no. 712-002.356-1), entitled “Flotation separation using lightweight synthetic bubbles and beads;”
PCT application no. PCT/US12/39524 (Atty docket no. 712-002.359-1), entitled “Mineral separation using functionalized polymer membranes;”
PCT application no. PCT/US12/39540 (Atty docket no. 712-002.359-2), entitled “Mineral separation using sized, weighted and magnetized beads;”
PCT application no. PCT/US12/39576 (Atty docket no. 712-002.382), entitled “Synthetic bubbles/beads functionalized with molecules for attracting or attaching to mineral particles of interest,” which corresponds to U.S. Pat. No. 9,352,335;
PCT application no. PCT/US12/39591 (Atty docket no. 712-002.383), entitled “Method and system for releasing mineral from synthetic bubbles and beads;”
PCT application no. PCT/US/39596 (Atty docket no. 712-002.384), entitled “Synthetic bubbles and beads having hydrophobic surface;”
PCT application no. PCT/US/39631 (Atty docket no. 712-002.385), entitled “Mineral separation using functionalized filters and membranes,” which corresponds to U.S. Pat. No. 9,302,270;”
PCT application no. PCT/US12/39655 (Atty docket no. 712-002.386), entitled “Mineral recovery in tailings using functionalized polymers;” and
PCT application no. PCT/US12/39658 (Atty docket no. 712-002.387), entitled “Techniques for transporting synthetic beads or bubbles In a flotation cell or column,” all of which are incorporated by reference in their entirety.

This application also related to PCT application no. PCT/US2013/042202 (Atty docket no. 712-002.389-1/CCS-0086), filed 22 May 2013, entitled “Charged engineered polymer beads/bubbles functionalized with molecules for attracting and attaching to mineral particles of interest for flotation separation,” which claims the benefit of U.S. Provisional Patent Application No. 61/650,210, filed 22 May 2012, which is incorporated by reference herein in its entirety.

This application is also related to PCT/US2014/037823, filed 13 May 2014, entitled “Polymer surfaces having a siloxane functional group,” which claims benefit to U.S. Provisional Patent Application No. 61/822,679 (Atty docket no. 712-002.395/CCS-0123), filed 13 May 2013, as well as U.S. patent application Ser. No. 14/118,984 (Atty docket no. 712-002.385/CCS-0092), filed 27 Jan. 2014, and is a continuation-in-part to PCT application no. PCT/US12/39631 (712-2.385//CCS-0092), filed 25 May 2012, which are all hereby incorporated by reference in their entirety.

This application also related to PCT application no. PCT/US13/28303 (Atty docket no. 712-002.377-1/CCS-0081/82), filed 28 Feb. 2013, entitled “Method and system for flotation separation in a magnetically controllable and steerable foam,” which is also hereby incorporated by reference in its entirety.

This application also related to PCT application no. PCT/US16/57334 (Atty docket no. 712-002.424-1/CCS-0151), filed 17 Oct. 2016, entitled “Opportunities for recovery augmentation process as applied to molybdenum production,” which is also hereby incorporated by reference in its entirety.

This application also related to PCT application no. PCT/US16/37322 (Atty docket no. 712-002.425-1/CCS-0152), filed 17 Oct. 2016, entitled “Mineral beneficiation utilizing engineered materials for mineral separation and coarse particle recovery,” which is also hereby incorporated by reference in its entirety.

This application also related to PCT application no. PCT/US16/62242 (Atty docket no. 712-002.426-1/CCS-0154), filed 16 Nov. 2016, entitled “Utilizing engineered media for recovery of minerals in tailings stream at the end of a flotation separation process,” which is also hereby incorporated by reference in its entirety.

This application also relates to PCT application no. PCT/US12/12689, filed 9 Jan. 2017 (Docket no. 712-002.428-1/CCS-0158) entitled “Recovery media for mineral processing, using open cell or reticulated foam having 3-dimensional functionalized open-network structure for selective separation of mineral particles in an aqueous system”, which claims benefit to provisional patent application Ser. No. 62/276,051, filed 7 Jan. 2016 (Docket no. 712-002.428/CCS-0158), entitled “Novel recovery media for mineral processing,” both of which are hereby incorporated by reference in its entirety.

All of the PCT applications and corresponding US patents are hereby incorporated by reference in their entirety.

I claim:

1. Apparatus for separating valuable material from unwanted material in a mixture, comprising:
engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy.

2. The apparatus according to claim 1, wherein the filler addition comprises hydrophilic silica added to a pre-cured polymer, including a pre-cured urethane foam.

3. The apparatus according to claim 1, wherein the filler addition comprises hydrophobic silica added to a pre-cured polymer, including a pre-cured urethane foam.

4. The apparatus according to claim 1, wherein the filler addition comprises a hydroxyl, an amine, a carboxyl, a carbonyl or an ester, all having reactive functionality or surface energy properties to enhance the coating adhesion and modify the polymer surface energy.

5. The apparatus according to claim 1, wherein the engineered media is formed by a composite of a polyurethane foam and silica, including either a hydrophilic silica or a hydrophobic silica.

6. The apparatus according to claim 5, wherein the composite of the polyurethane foam and the hydrophilic silica is coated with polydimethylsiloxane (PDMS) having PDMS silanols to attract the valuable material in the mixture, so that the PDMS silanols covalently react with and hydrogen bond to hydroxyl functionality on the hydrophilic silica on a polyurethane foam surface of the polyurethane foam.

7. The apparatus according to claim 5, wherein the composite of the polyurethane foam and the hydrophobic silica is coated with hydrophobic silicone to attract the valuable material in the mixture, so that hydroxyl functionality on the hydrophobic silica allows both hydrogen and covalent bonding of the hydrophobic silicone coated on the polyurethane foam.

8. The apparatus according to claim 5, wherein the body comprises a conveyor belt made from the composite of the polyurethane foam and silica, including either the hydrophilic silica or the hydrophobic silica.

9. The apparatus according to claim 5, wherein the body comprises a filter made from the composite of the polyurethane foam and silica, including either the hydrophilic silica or the hydrophobic silica.

10. The apparatus according to claim 1, wherein the filler addition comprises glass fiber, talc, mica or aluminosilicates, all having reactive functionality or surface energy properties to enhance the coating adhesion and modify the polymer surface energy.

11. The apparatus according to claim 1, wherein the polymer comprises polyethylene (PE), polypropylene (PP), or polyurethane.

12. The apparatus according to claim 1, wherein the coating is made of a hydrophobic material selected from poly(dimethylsiloxane), polysiloxanates and fluoroalkylsilane.

13. The apparatus according to claim 1, wherein the synthetic material comprises a polymer-based material, silica-based material or ceramic-based material.

14. The apparatus according to claim 1, wherein the body comprises a synthetic bead having the polymer surface, and the synthetic bead is made of a material having a density less than the density of water.

15. The apparatus according to claim 1, wherein the engineered media comprises a three-dimensional open-cell structure made of a material selected from the group consisting of polyester urethanes (PU), reinforced urethanes, composites like polyvinylchloride (PVC) coated PU, carbon fiber foams and hard plastics.

16. The apparatus according to claim 1, wherein the engineered media comprises synthetic beads, each having the polymer surface.

17. The apparatus according to claim 16, wherein each synthetic bead is made from the polymer having the filler addition added prior to curing.

18. The apparatus according to claim 1, wherein the engineered media comprises one or more moving conveyor belts having the polymer surface.

19. The apparatus according to claim 1, wherein the engineered media comprises one or more filters having the polymer surface.

20. The apparatus according to claim 1, wherein the engineered media forms a resulting product characterized as either a filler-enhanced foam, a silica-enhanced composite polymer

21. A method for separating valuable material from unwanted material in a mixture, comprising:
forming engineered media made of synthetic material from a body having a polymer surface with a coating functionalized to attract valuable material in a mixture;
configuring the polymer surface from a polymer having a filler addition added prior to curing in order to enhance coating adhesion and modify polymer surface energy; and
separating valuable material from unwanted material in a mixture using the engineered media.

22. The method according to claim 21, wherein the method comprises configuring the filler addition with hydrophilic silica added to a pre-cured polymer, including a pre-cured urethane foam.

23. The method according to claim 21, wherein the method comprises configuring the filler addition with hydrophobic silica added to to a pre-cured polymer, including a pre-cured urethane foam.

24. The method according to claim 21, wherein the method comprises configuring the filler addition with a hydroxyl, an amine, a carboxyl, a carbonyl or an ester, all having reactive functionality or surface energy properties to enhance the coating adhesion and modify the polymer surface energy.

25. The method according to claim 21, wherein the method comprises forming the engineered media from a composite of a polyurethane foam and silica, including either a hydrophilic silica or a hydrophobic silica.

26. A system for separating valuable material from unwanted material in a mixture, comprising:
engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy;
an attachment flotation column configured to receive the engineered media and a mixture having valuable material and unwanted material, and provide enriched engineered media having the valuable material attached thereto; and
a release flotation column configured to receive the enriched engineered media, and provide reclaimed engineered media and the valuable material released from the enriched engineered media.

27. The system according to claim 26, wherein the filler addition comprises hydrophilic silica added to a pre-cured polymer, including a pre-cured urethane foam.

28. The system according to claim 26, wherein the filler addition comprises hydrophobic silica added to a pre-cured polymer, including a pre-cured urethane foam.

29. The system according to claim 26, wherein the filler addition comprises a hydroxyl, an amine, a carboxyl, a carbonyl or an ester, all having reactive functionality or surface energy properties to enhance the coating adhesion and modify the polymer surface energy.

30. The system according to claim 26, wherein the engineered media is formed by a composite of a polyurethane foam and silica, including either a hydrophilic silica or a hydrophobic silica.

31. A system for separating valuable material from unwanted material in a mixture, comprising:
engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy;
attachment apparatus configured to receive the engineered media in the form of a conveyor belt and a mixture having valuable material and unwanted material, and provide an enriched conveyor belt having the valuable material attached thereto; and
release apparatus configured to receive the enriched conveyor belt, and provide a released conveyor belt and the valuable material released from the enriched conveyor belt.

32. The system according to claim 31, wherein the filler addition comprises hydrophilic silica added to a pre-cured polymer, including a pre-cured urethane foam.

33. The system according to claim 31, wherein the filler addition comprises hydrophobic silica added to a pre-cured polymer, including a pre-cured urethane foam.

34. The system according to claim 31, wherein the filler addition comprises a hydroxyl, an amine, a carboxyl, a carbonyl or an ester, all having reactive functionality or surface energy properties to enhance the coating adhesion and modify the polymer surface energy.

35. The system according to claim 31, wherein the engineered media is formed by a composite of a polyurethane foam and silica, including either a hydrophilic silica or a hydrophobic silica.

36. A system for separating valuable material from unwanted material in a mixture, comprising:
engineered media made of synthetic material and formed by a body having a polymer surface with a coating functionalized to attract valuable material in a mixture, the polymer surface being made from a polymer having a filler addition added prior to curing in order to enhance coating adhesion and modify polymer surface energy;
attachment apparatus configured to receive the engineered media in the form of a filter and a mixture having valuable material and unwanted material, and provide an enriched filter having the valuable material attached thereto; and
release apparatus configured to receive the enriched filter, and provide a released filter belt and the valuable material released from the enriched filter.

37. The system according to claim 36, wherein the filler addition comprises hydrophilic silica added to a pre-cured polymer, including a pre-cured urethane foam.

38. The system according to claim 36, wherein the filler addition comprises hydrophobic silica added to a pre-cured polymer, including a pre-cured urethane foam.

39. The system according to claim 36, wherein the filler addition comprises a hydroxyl, an amine, a carboxyl, a carbonyl or an ester, all having reactive functionality or surface energy properties to enhance the coating adhesion and modify the polymer surface energy.

40. The system according to claim 36, wherein the engineered media is formed by a composite of a polyurethane foam and silica, including either a hydrophilic silica or a hydrophobic silica.
